(19) United States
(12) Patent Application Publication
(10) Pub. No.: US 2026/0056726 A1
(43) Pub. Date: Feb. 26, 2026

(54) TECHNIQUES FOR OPTIMIZED AUTOMATED SOFTWARE UPDATE IMPLEMENTATION

(71) Applicant: T-Mobile USA, Inc., Bellevue, WA (US)

(72) Inventor: Relin Thomas, Bellevue, WA (US)

(21) Appl. No.: 18/814,921

(22) Filed: Aug. 26, 2024

(51) Int. Cl. G06F 8/65

(52) U.S. Cl. CPC G06F 8/65

(57) ABSTRACT

Techniques are described herein for implementing automated installation of software updates on user equipment while minimizing disruptions to predicted data usage. In embodiments, such techniques may comprise upon identifying a software update to be implemented on a user equipment in communication with the network node, determining, based on information about the software update, a time window within which the software update is to be implemented. The techniques may further comprise generating, based on information about the user equipment, a predicted data usage schedule associated with the time window, determining, based on the predicted data usage schedule, a start time for an installation period associated with the software update, and providing instructions to the user equipment to cause the user equipment to install the software update at the start time.

### BACKGROUND

Cellular networks are frequently used to enable communication between various mobile devices. Mobile devices operating on such networks may access a number of services that provided on backend servers via those networks. Such access is typically achieved through software applications associated with the services, which can become outdated. However, keeping each of the software applications on a mobile device updated may be disruptive to the use of the mobile device.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 depicts a diagram illustrating an overview of a network architecture 100 having a number of components that may be implemented in accordance with some embodiments.

FIG. 2 depicts a component diagram of an example system to be implemented in a network in order to enable implementation of automated software updates in accordance with some embodiments.

FIG. 3 depicts a graphical illustration of a predicted data usage schedule that may be generated to identify a start time for a user equipment in accordance with embodiments.

FIG. 4 depicts a swim lane diagram illustrating an exemplary process for implementing automated software updates on a user equipment in accordance with some embodiments.

FIG. 5 depicts a block diagram illustrating interactions that may be conducted between a number of components in accordance with at least some embodiments.

FIG. 6 depicts a flow diagram illustrating an exemplary process for optimization automatization of software update installation in accordance with at least some embodiments.

FIG. 7 shows an example computer architecture for a computing device capable of executing program components for implementing the functionality described above.

### DETAILED DESCRIPTION

This disclosure describes techniques that may be performed to provide automated installation of software updates on user equipment while minimizing disruptions to data usage on that user equipment.

In embodiments, a network node (e.g., a scheduling node) may determine that one or more user equipment (UE) requires installation of a software update. Upon making such a determination, the network node may identify a time window within which the software update should be installed. In embodiments, a length of the time window may be dependent upon a level of criticality associated with the software update or a service related to that software update. The network node may then generate a predicted data usage schedule for the UE over the identified time window based on historical data usage for that UE.

An installation period can be determined for the software update representing an amount of time that an installation of the software update is predicted to take, wherein a length of that installation period may be dependent upon a size of the software update. Once a predicted data usage schedule has been generated, a start time can be predicted for the installation period that minimizes disruption of data usage on the UE within the time window. Once a start time has been determined in this manner, the network node may relay instructions to the UE along with the software update to cause the UE to automatically install the software update at the determined start time absent any human (e.g., UE operator) interaction.

Embodiments of the disclosure provide for a number of advantages over conventional systems. For example, conventional systems may typically require user/operator approval to perform a software update on a user equipment. However, this can result in a number of problems. For example, major security risks can be introduced when the software update is intended to fix a security issue and an operator will not approve its installation. However, forcing the software update to be installed can be very disruptive if the installation is being performed when the user has a need to use the user equipment.

In contrast, the proposed system provides for a software update to be installed automatically at a time that is determined to be optimal for that installation based on information specific to that user equipment. In embodiments, software updates are installed on the user equipment automatically while a disruption to the use of that user equipment is minimized.

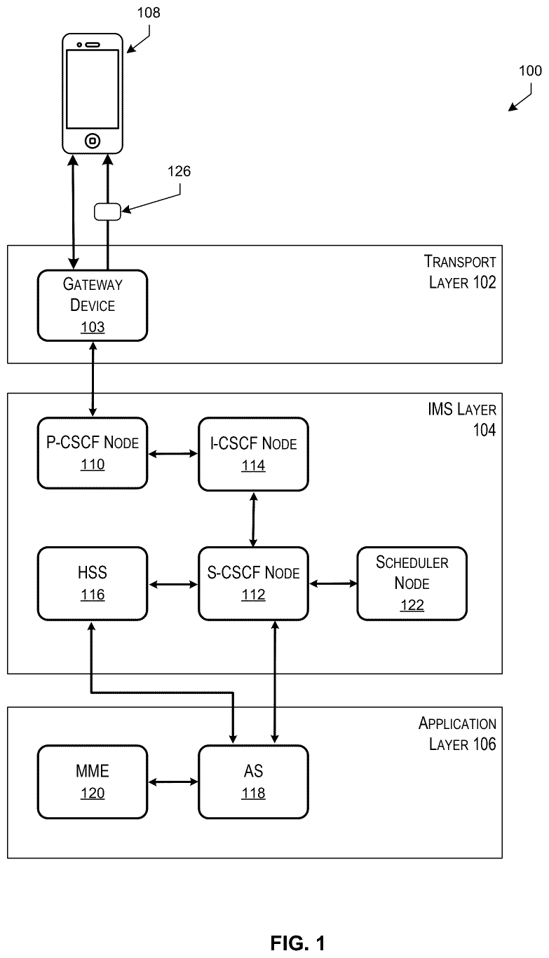

FIG. 1 depicts a diagram illustrating an overview of a network architecture 100 having a number of components that may be implemented in accordance with some embodiments. In embodiments, the network architecture 100 may be made up of multiple layers, each of which includes a different set of nodes. For example, the network architecture 100 may be representative of an IMS network that includes at least a transport layer 102, an IMS layer 104, and an application layer 106.

A transport layer 102 is responsible for connecting different access technologies users'devices to the IMS domain and for connection of the domain to other packet-switched and circuit-switched networks. A transport layer 102 may include any node (e.g., equipment) configured to provide access (e.g., ingress/egress) to the network architecture 100 for a number of user equipment (UE) 108. For example, a transport layer 102 may include a gateway device, such as a gateway device 103 that provides fixed access (e.g., digital subscriber line (DSL), cable modems, Ethernet, FTTx), mobile access (e.g., 5G NR, LTE, W-CDMA, CDMA2000, GSM, GPRS), and/or wireless access (e.g., WLAN, WiMAX).

An IMS layer 104 (also referred to as a control layer) may include any node configured to process SIP signaling packets within the network architecture 100. Such nodes may generally be referred to as Call Session Control Function (CSCF) nodes. CSCF nodes can be further distinguished based on their respective roles. For example, CSCF nodes may include a Proxy CSCF (P-CSCF), a Service CSCF (S-CSCF), and an Interrogating CSCF (I-CSCF). It is to be appreciated that the IMS network can include additional nodes that are not described herein such as nodes including, without limitation, an emergency CSCF (E-CSCF) node, a security gateway (SEG), a session border controller (SBC), and so on. In some cases, the IMS layer 104 may further include a Home Subscriber Server (HSS) 116. However, it should be noted that while the HSS 116 is depicted in the IMS layer 104 in FIG. 1, the HSS 116 may instead be implemented within an application layer 106 in some embodiments of a network architecture 100 or even outside of the IMS network.

A P-CSCF node is a proxy device that acts as a first point of contact for UE 108 within the IMS Network. Each UE is assigned to a respective P-CSCF when it is registered with the IMS Network. A P-CSCF node can receive, via a communications interface, a Session Initiation Protocol (SIP) request from the UE 108 to be forwarded to a S-CSCF.

A S-CSCF node is the central nodes of the signaling plane and sits on the path of all signaling messages to/from a UE 108 that is assigned to it. There can be multiple S-CSCFs in the network for load distribution and high availability reasons. A S-CSCF is typically assigned to a user (or UE) by a Home Subscriber Server (HSS), when it's queried by the I-CSCF.

A S-CSCF node 112 may represent one of multiple available S-CSCF nodes (e.g., 112 (A-C)) that is chosen (or otherwise selected) for assignment to the UE 108. S-CSCF nodes, such as the S-CSCF node 112 (A), are sometimes referred to as “Registrars,” and the process of allocating Registrars among users who are registering for IMS-based services is sometimes referred to as finding a “home CSCF”for the UE 108.

A I-CSCF node 114 is a SIP function node that acts as a forwarding point for external devices. The I-CSCF node 114 queries the HSS to determine S-CSCF/UE mapping and forwards SIP requests between the P-CSCF node 110 and the respective S-CSCF node 112.

The HSS 116 is typically a master user database that supports the IMS network nodes that handle the calls/sessions. It contains user profiles, performs authentication and authorization of the user, and can provide information about the physical location of a user. A user profile may be associated with each UE 108 and may contain information about the current user. Such information may be downloaded by the S-CSCF assigned to the user when the user is registered on the network. The S-CSCF may typically receive that information in a User-data Attribute Value Pair (AVP) format.

An application layer 106 (also referred to as a service layer) may include one or more nodes capable of providing IMS-related services to the UE 108. In embodiments, the application layer 106 may include at least a number of Application Servers (AS) 118, as well as a Mobility Management Entity (MME) 120. As noted above, the application layer 106 may further include a HSS 116 in some embodiments.

An AS 118 hosts and executes services, and interface with the S-CSCF using messages formatted using a SIP protocol. Depending on the actual service, the AS 118 can operate in SIP proxy mode, SIP UA (user agent) mode or SIP B2BUA mode. An AS 118 can be located in the network architecture 100 or in an external third-party network. If located in the network architecture 100, it may be able to query, or otherwise interact with the HSS 116 (e.g., using Diameter interfaces). In embodiments, the AS 118 manages an application that provides communication between two or more UEs (e.g., UE 108 and at least one other UE). For example, the AS 118 may manage an application that provides Voice over IP (VoIP) communications between UE devices.

In embodiments, an AS 118 may be configured to make service initiation decisions based on information about a UE 108 to which a communication is being directed. For example, the AS 118 may receive a communication directed to initiation of a service at a UE 108. By way of illustration, another UE may initiate a Voice over Internet Protocol (VoIP) call to a UE 108. In this illustration, the AS 118 receives a request to initiate the VoIP call as well as an identifier for the UE 108. Upon receiving such a communication, the AS 118 may retrieve information about the UE 108 from a second entity that maintains updated information about a status of the UE 108. Such a communication may be routed through the HSS 116. For example, the AS 118 may provide a request to the HSS 116 (which maintains information about services associated with the account for that UE 108) and the HSS 116 further communicates with an MME 120 to retrieve such information. The AS 118 may then make a determination about whether the service should or should not be initiated based on the received information and absent additional communications within the network architecture 100.

The network architecture 100 may include at least one node that provides an update scheduling function (e.g., scheduler node 122) that is configured to push automatic update instructions (along with a software update 126) to one or more UEs 108. In embodiments, the scheduler node 122 may be configured to determine a best time period within a time window that a software update should be installed/implemented. In such cases, a length of the time window may be dependent upon a criticality associated with the software update whereas a length of the time period is determined based on a type or category of the UE 108 as well as a size of the software update.

In embodiments, the scheduler node 122 may determine one or more software updates to be installed upon one or more UEs operating on the network architecture 100. The scheduler node 122 may determine information about the software update, such as a level of criticality associated with the software update as well as a size of that software update. Additionally, the scheduler node 122 may determine information about the UE and/or its operator. For example, the scheduler node 122 may determine a type or category (e.g., a model) of the UE as well as a data usage schedule for the operator of the UE based on historical data usage patterns. In some embodiments, at least a portion of the information determined by the scheduler node 122 may be determined using one or more trained machine learning models.

With respect to a software update 126 determined to be required by a UE, the scheduler node 122 may be configured to determine, based on a type of the UE to receive the software update and a size of the update, a length of a period of time to be taken to implement that software update. The scheduler node 122 may then determine a time period within which the software update should be implemented on the UE 108 based on historical usage data for the operator of the UE. The scheduler node 122 may then package the software update 126 with instructions to cause the UE 108 to implement that software update at the determined time period.

The UE 108 may include any electronic device capable of interacting with the network architecture 100. In some non-limiting examples, the UE 108 may be a variety of devices including, for example: a mobile phone, a personal data assistant (PDA), or a mobile computer (e.g., a laptop, notebook, notepad, tablet, etc.) having mobile wireless data communication capability. The UE 108 may be configured to register for, and thereafter access and utilize, one or more IMS-based services via the network architecture 100. To this end, the UE 108 may be configured to transmit, via a radio access network (RAN), messages to the IMS network. For example, the UE 108 may transmit messages to the IMS network as part of an IMS registration procedure where the UE 108 is requesting to register for an IMS-based service.

In operation, the UE 108 may, upon registration with the network architecture 100, be assigned to a P-CSCF node 110 as well as a S-CSCF node 112. Communications from the UE 108 to an AS 118 of the network architecture 100 are then routed from the UE 108 to the P-CSCF node 110 and then to the S-CSCF node 112 (through forwarding by the I-CSCF node 114) and subsequently to the AS 118. Conversely, communications from an AS 118 of the network architecture 100 to the UE 108 are routed from the AS 118 to the S-CSCF node 112 and then to the P-CSCF node 110 and subsequently to the UE 108.

During operation, one or more AS 118 may provide information about a software update to be implemented with respect to one or more service or application that it maintains. For example, the application server may manage operation of a service that is provided to a number of UEs. In this example, the service may be accessed via an API by software application installed on the UE 108. When the service is updated, a newer version of the software application may need to be installed on the UE in order for that UE to be able to access the updated service. Hence, the AS 118 may provide information about a software update to the scheduler node 122 that will need to be implemented on various UEs in order for those UEs to continue to access the service. In some cases, the software update may be assigned a level of criticality a level of criticality of the service.

In accordance with various embodiments described herein, the terms “user equipment (UE),” “wireless communication device,” “wireless device,” “communication device,” “mobile device,” and “client device,” may be used interchangeably herein to describe any UE (e.g., the UE 108) that is capable of transmitting/receiving data over the IMS network, perhaps in combination with other networks. A users can utilize the UE 108 to communicate with other users and associated UEs via the IMS network. For example, a service provider may offer multimedia telephony services that allow a subscribed user to call or message other users via the IMS network using his/her UE 108. A user can also utilize the UE 108 to receive, provide, or otherwise interact with various different IMS-based services by accessing the IMS network. In this manner, an operator of the IMS network may offer any type of IMS-based service, such as, telephony services, emergency services (e.g., E911), gaming services, instant messaging services, presence services, video conferencing services, social networking and sharing services, location-based services, push-to-talk services, and so on.

Furthermore, the IMS network that includes the IMS nodes 110-114 may enable peer-to-peer, client-to-client, and/or client-to-server, communications over wired and/or wireless networks using any suitable wireless communications/data technology, protocol, or standard, such as Global System for Mobile Communications (GSM), Time Division Multiple Access (TDMA), Universal Mobile Telecommunications System (UMTS), Evolution-Data Optimized (EVDO), Long Term Evolution (LTE), Advanced LTE (LTE+), Generic Access Network (GAN), Unlicensed Mobile Access (UMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), High Speed Packet Access (HSPA), evolved HSPA (HSPA+), Voice over IP (VoIP), Voice over LTE (VoLTE), IEEE 802.1x protocols, WiMAX, Wi-Fi, Data Over Cable Service Interface Specification (DOCSIS), digital subscriber line (DSL), and/or any future IP-based network technology or evolution of an existing IP-based network technology.

The network architecture 100 of FIG. 1 may be maintained and/or operated by one or more service providers, such as one or more wireless carriers (“operators”), that provide mobile IMS-based services to users (sometimes called “subscribers”) who are associated with UEs, such as the UE 108. The IMS network may represent any type of SIP-based network that is configured to handle/process SIP signaling packets or messages. SIP is a signaling protocol that can be used to establish, modify, and terminate multimedia sessions (e.g., a multimedia telephony call) over packet networks, and to authenticate access to IMS-based services. Individual nodes of the IMS nodes 110-114 of FIG. 1 can also be configured to transmit data to/from the HSS 116 using Diameter protocol over a Diameter interface. In one example, such a Diameter interface may be a Diameter (Cx) when the interface is accessed via a I/S-CSCF node. In another example, such a Diameter interface may be a Diameter (Sh) when the interface is accessed via an application server. Diameter protocol is defined by the Internet Engineering Task Force (IETF) in RFC 6733.

For clarity, a certain number of components are shown in FIG. 1. It is understood, however, that embodiments of the disclosure may include more than one of each component. In addition, some embodiments of the disclosure may include fewer than or greater than all of the components shown in FIG. 1. In addition, the components in FIG. 1 may communicate via any suitable communication medium (including the Internet), using any suitable communication protocol.

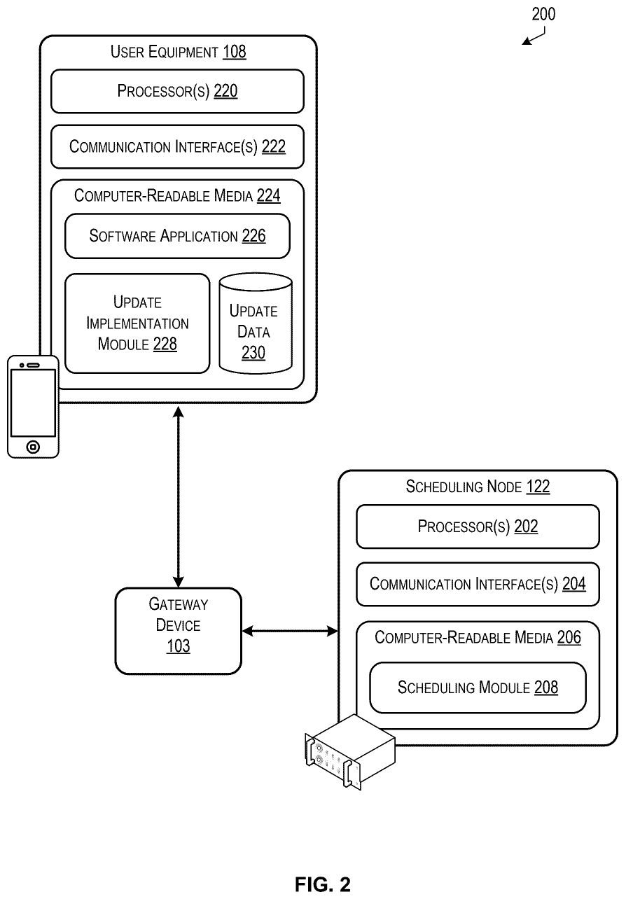

FIG. 2 depicts a component diagram of an example system to be implemented in a network (e.g., an IMS network) in order to enable implementation of automated software updates in accordance with some embodiments. As depicted in FIG. 2, a scheduler node 122 may be in wireless communication with a UE 108 that is operated by a user. The connection between the UE 108 and the network node operating on a network may be made over a gateway device 103.

In some embodiments, an exemplary scheduling node 122 of FIG. 2 may be an example of a scheduler node 122 as described in relation to FIG. 1 above. In some embodiments, the scheduling node 122 is implemented in communication with a gateway device 103. Gateway device 103 may be an example of the gateway device as described in relation to FIG. 1 above. It should be noted that such an IMS node (or any other described computing component) may include a single computing device (e.g., a server device) or a combination of computing devices. In some cases, the IMS node may be implemented as a virtual device/system (e.g., via virtual machines implemented within a cloud computing environment).

As illustrated, the scheduling node 122 may include one or more hardware processors 202 configured to execute one or more stored instructions. Such processors 202 may comprise one or more processing cores. Further, the scheduling node 122 may include one or more communication interfaces 204 configured to provide communications between the scheduling node 122 and other devices, such as the UE 108 or any other suitable electronic device.

The scheduling node 122 may also include computer-readable media 206 that stores various executable components (e.g., software-based components, firmware-based components, etc.). The computer-readable media 206 may store components to implement functionality described herein. While not illustrated, the computer-readable media 206 may store one or more operating systems utilized to control the operation of the one or more devices that comprise the scheduling node 122. According to one instance, the operating system comprises the LINUX operating system. According to another instance, the operating system(s) comprise the WINDOWS® SERVER operating system from MICROSOFT Corporation of Redmond, Washington. According to further embodiments, the operating system(s) can comprise the UNIX operating system or one of its variants. It should be appreciated that other operating systems can also be utilized.

The computer-readable media 206 may include portions, or components, that configure the scheduling node 122 to perform various operations described herein. For example, the computer-readable media 206 may include some combination of components configured to implement the described techniques. Particularly, the scheduling node 122 may include a component configured to determine scheduling information for a software update and/or UE and provide instructions to implement that software update (e.g., scheduling module 208). Additionally, the computer-readable media 206 may further maintain one or more databases.

A scheduling module 208 may be configured to, when executed by the processors 202, determine that a software update should be installed on a UE. In embodiments, this may involve determining whether a current version of a software application 226 installed on the UE 108 is the most recent or updated version of the software application available. A software update may be determined to be needed if the current version is not the most recent version available. In such cases, the scheduling module 208 may be configured to identify a software update that will bring the software application up to the most recent version. In some cases, the software update needed may be determined based on a type (e.g., a model) of the UE. For example, multiple versions of a software update may be maintained, such that different versions of the software update may be associated with different operating systems/UE models.

The scheduling module 208 may be configured to determine, based at least on a size of the determined software update (and in some cases based on the model of the UE), an amount of time that the installation of the software update is predicted to take (e.g., an installation period). Additionally, the scheduling module 208 may be further configured to determine a time window (e.g., 10 hours) within which the software update should be installed. In embodiments, a length of that time window may be determined based on a level of criticality associated with the software update. In some cases, the level of criticality associated with the software update may correspond to a level of criticality associated with an underlying service related to that software update.

The scheduling module 208 may be further configured to generate a predicted data usage schedule for the UE over the determined time window. The predicted data usage schedule may represent predicted data usage schedule by the UE at each of a number of points in time throughout the time window. Such a predicted data usage schedule may be generated based on historical data usage by an operator of the UE. In some cases, the predicted data usage schedule may be generated by a trained machine learning model.

Once a predicted data usage schedule has been generated for the UE over the determined time window, the scheduling module 208 may be configured to identify a start time within that time window to start the software update. In embodiments, the start time may be determined such that it minimizes disruption to predicted data usage schedule based on the information in the predicted data usage schedule. The scheduling module 208 may then generate instructions to be packaged with the software update that, when implemented by the UE, causes the software update to be installed on the UE starting at the determined start time.

The UE 108 may be an example of a UE 108 as described in relation to FIG. 1 above. As noted elsewhere, a UE 108 may include any suitable electronic device configured to interact with a network.

Similar to the scheduling node 122, the UE 108 may include one or more hardware processors 220 configured to execute stored instructions. Such processor(s) 220 may comprise one or more processing cores. Further, the UE 108 may include one or more communication interfaces 222 configured to provide communications between the UE 108 and other devices, such as a scheduling node 122 or another suitable electronic device.

Similar to the scheduling node 122, the UE 108 may include computer-readable media 224 that stores various executable components (e.g., software-based components, firmware-based components, etc.). The computer-readable media 224 may store components to implement functionality described herein. It should be appreciated by those skilled in the art that computer-readable storage media may include any available media that provides for the non-transitory storage of data and that can be accessed by the UE 108. In some examples, the operations performed by devices as described herein may be supported by one or more devices similar to UE 108. Stated otherwise, some or all of the operations performed by a UE, and/or any components included therein, may be performed by one or more computing device operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

The computer-readable media 224 may include portions, or components, that configure the UE 108 to perform various operations described herein. For example, the computer-readable media 224 may include some combination of components configured to implement the described techniques. In embodiments, the computer-readable media 224 of the UE 108 may include one or more software application(s) 226. The computer-readable media 224 may further include a component configured to implement a software update during a specified time window (e.g., update implementation module 228). Additionally, the computer-readable media 224 may further maintain one or more databases, such as a data store holding software updates to be implemented at a later time (e.g., update data 230).

A software application 226 may be any suitable set of computer-executable instructions that causes the UE 108 to perform a function. In embodiments, the software application 226 may be supported by a remote server, such as an AS 118 as described in relation to FIG. 1 above. In other words, when executed, the software application may cause the UE 108 to communicate with a remote server to perform at least a portion of the functionality provided by that software application 226. The network traffic generated during such a communication may be transmitted to the gateway device 103 to be routed to its intended destination device.

An update implementation module 228 may be configured to, when executed by the processors 220, cause a software update to be implemented on the UE at a specified time. For example, the software update may be implemented for the one or more software application(s) 226. In some cases, the UE 108 may receive a software update from the scheduler node 122 to be implemented on the UE. The software update may include instructions to cause the software update to be implemented along with a specified start time to be stored in update data 230. It should be noted that while the software update and corresponding start time may be received at any time, the software update is not implemented until the start time has been reached.

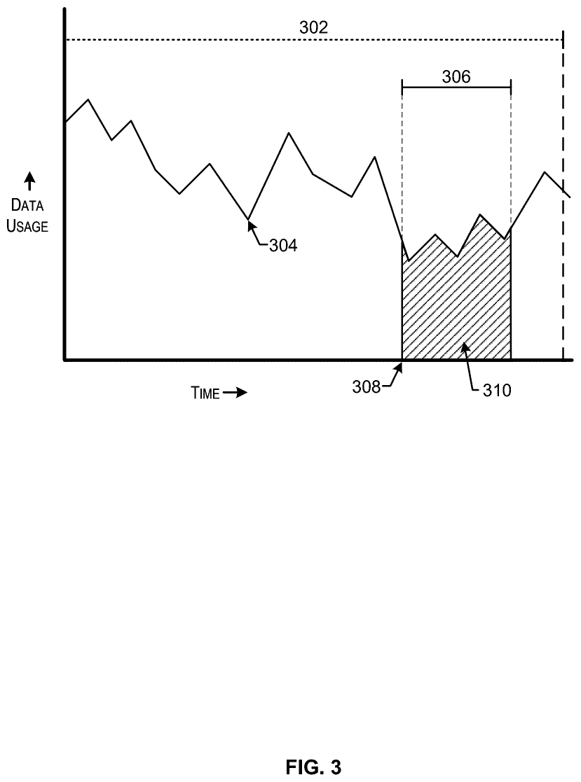

FIG. 3 depicts a graphical illustration of a predicted data usage schedule that may be generated to identify a start time for a UE in accordance with embodiments. As noted elsewhere, a scheduling module may generate a predicted data usage schedule that represents a predicted amount of data that will be consumed by the UE with respect to time. The predicted data usage schedule may be generated for a UE upon determining that a software update should be installed on that UE.

As noted elsewhere, the predicted data usage schedule may be generated to include all predicted data usage by the UE over a specified time window 302. In embodiments, a length of the time window 302 may be determined based on a level of criticality associated with a software update to be installed on the UE. Notably, the length of the time window 302 may be inversely correlated to the level of criticality of the software update, in that a higher level of criticality may correspond to a shorter time window 302.

For illustrative purposes, the data usage for the UE over the time window 302 is represented as a graphical curve 304 with respect to time. In FIG. 3, time is depicted along the X-axis whereas predicted data usage is depicted along the Y-axis.

As noted elsewhere, an installation period 306 may be calculated that represents an amount of time that installation of the software update is predicted to take. In order to determine an optimal start time 308 for the installation period 306, a network node may calculate a total data usage over the installation period 306 for any given start time (represented in FIG. 3 as a total area 310 under the curve 304 over the installation period). In embodiments, an optimal start time 308 may be determined by identifying a position of the installation period for which the area under the curve 310 is minimized in relation to the rest of the time window 302.

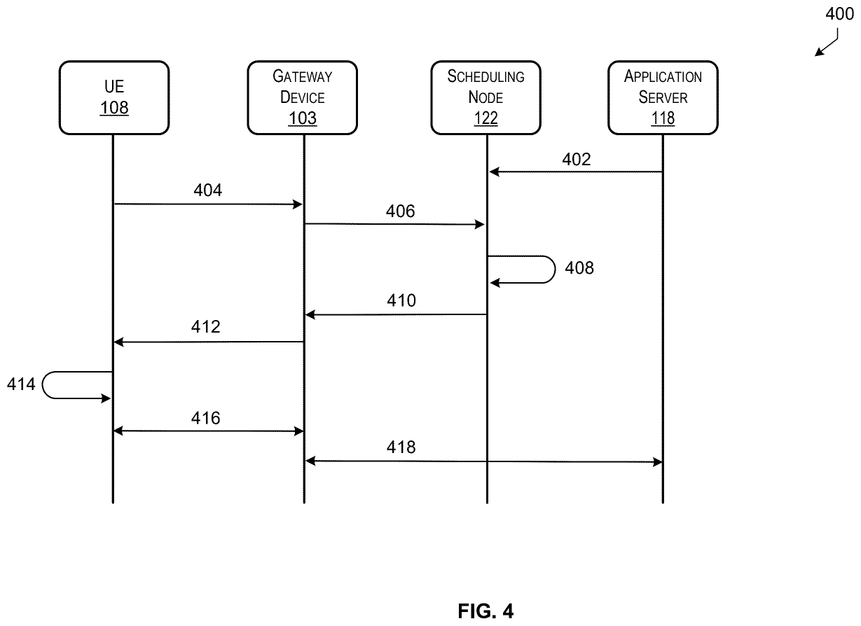

FIG. 4 depicts a swim lane diagram illustrating an exemplary process for implementing automated software updates on a UE in accordance with some embodiments. The process 400 may include a number of interactions between various components as described in relation to the network architecture 100 of FIG. 1. More particularly, the process 400 may involve interactions between a UE 108, a gateway device 103, a scheduling node 122, and at least one application server 118.

At 402 of the process 400, a scheduling node operating on a network (e.g., within an IMS network) may receive information about one or more software updates from at least one application server 118. A software update received by the scheduling node 122 may relate to updates to a software application that is capable of accessing a service maintained by the application server 118.

At 404 of the process 400, a UE 108 may connect to a gateway device 103. In some cases, when such a connection is established, the UE 108 may be registered with a network on which the scheduling node 122 is operating. Information about the UE 108 may be relayed to the scheduling node 122 at 406. Such information may include an indication of a model or type associated with the UE 108. In some embodiments, the gateway device 103 may relay information about a software application that the UE 108 is attempting to access or has accessed in the past.

The scheduling node 122 may retrieve information about the UE 108 from either the UE itself or from another node of the network (e.g., a HSS 116 as described in relation to FIG. 1 above). In some cases, such information may include an indication of historic data usage activities for the UE 108, which may be represented with respect to time.

At 408 of the process 400, a determination may be made by the scheduling node 122 that the UE 108 should receive one or more software updates. In some cases, such a determination may be made based on determining that a current version of a software application installed on the UE is not the most recent or updated version of that software application available (e.g., based on software update information provided to the scheduling node 122 by the application server 118).

Upon making that determination, time window may be determined within which the software update should be implemented on the UE. As noted elsewhere, a length of the time window may correspond (inversely) with a level of criticality for the software update (or an underlying service associated with that software update). For example, a shorter time window may be calculated for a software update that is more critical.

The scheduling node 122 may then generate a predicted data usage schedule for the UE over that time window. In embodiments, such a predicted data usage schedule may be generated based on historic data usage patterns exhibited by the UE 108 or an operator associated with that UE. In some cases, the predicted data usage schedule is generated using a machine learning model that has been trained to generate predicted data usage schedules as output while accepting historic data usage information as input. Additionally, the scheduling node 122 may predict an amount of time that is likely to be taken to install the software update on the UE 108 (e.g., installation period) based on a size of the software update, information about a communication connection for the UE (e.g., an amount of bandwidth, quality of connection, etc.), and a type of the UE.

Once a predicted data usage schedule has been generated for the UE 108, a determination may be made as to a start time for the installation period within the time window for which an impact on predicted data usage is minimized. The scheduling node 122 may provide the software update to the UE along with instructions to cause the UE to install that software update at the determined start time. At 410 of the process 400, the software update and instructions are provided to the gateway device 103, where it is then relayed to the UE 108 at 412.

At 414 of the process 400, the UE 108 may store the received software update and generated instructions for installing the software update at the indicated start time. When the indicated start time is reached, the instructions are executed (e.g., by an update implementation module 228 as described in FIG. 2 above) to cause the UE 108 to automatically (e.g., without user interaction) begin the installation of the software update. In some cases, the UE 108 may be restarted after completing the installation of the software update.

Once the software update has successfully been installed, the UE 108 may attempt to access a service managed by the application server 118 associated with the software update. At 416 of the process 400, the UE 108 establishes a connection between itself and the gateway device 103. At 418 of the process 400, the gateway device 103 establishes a connection between itself and the application server 118 that manages the service. Communications are then routed between the application server 118 and the UE 108 over the established communication sessions.

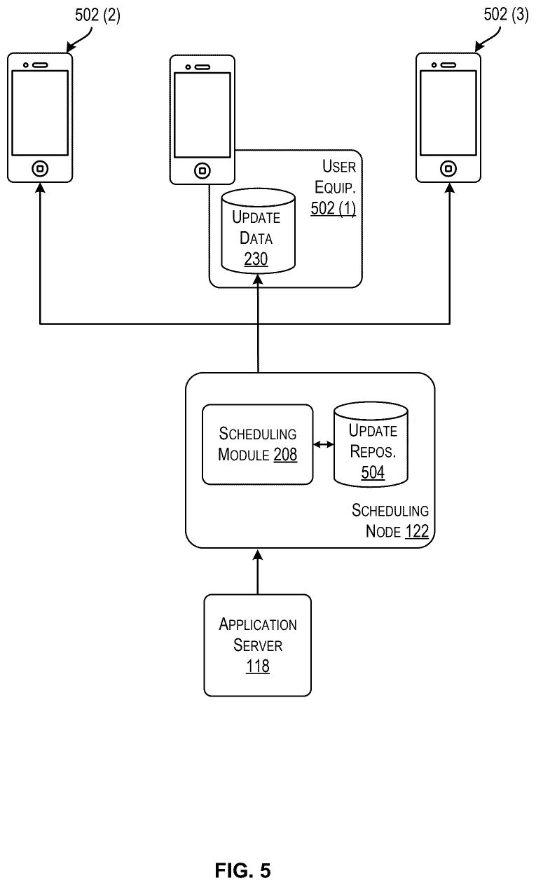

FIG. 5 depicts a block diagram illustrating interactions that may be conducted between a number of components in accordance with at least some embodiments. As depicted in FIG. 5, multiple UEs 502 (1-3) may be in communication with a network that includes at least one scheduling node 122 and one or more application server 118.

As noted elsewhere, an application server 118 may be configured to, when a new software update is made available, transmit that software update (or information about the software update) to a scheduling node 122. In some cases, multiple versions of the new software update may be made available to the scheduling node 122, with each of the multiple software update versions being associated with a different operating system or device type. In embodiments, the software updates and/or the information about the software updates may be stored by the scheduling node 122 within an update repository 504.

Upon receiving information about a number of UEs 502 (1-3) that are in communication with the network that includes the scheduling node 122, a scheduling module 208 may make a determination as to which of those UEs 502 (1-3) require a software update. In some embodiments, this may involve the scheduling node 122 receiving information that indicates a current installed version of each of a number of software applications. In some embodiments, a notification may be generated when a UE 502 attempts to access a service managed by an application server 118 using a software application that is outdated (e.g., not the most recent version).

Upon determining that at least one UE requires a software update to be installed, the scheduling node 122 may be configured to generate a predicted data usage schedule for each of those UEs in order to determine an appropriate start time for an installation period for the software update. Note that in this example, each of the generated predicted data usage schedules for the UEs 502 may be specific to those UEs. Each of the predicted data usage schedules may be generated using historic data usage information for the respective UE 502.

In embodiments, the scheduling module 208 may be configured to provide each of the UEs 502 determined to require a software update with a version of that software update relevant to it. The scheduling module 208 may further provide an indication of a different start time for each respective UE to install the respective software update along with instructions to cause the respective UE to perform the installation at the indicated start time. In embodiments, when a UE 502 (2) receives a software update and indicated start time, that information may be stored in update data 230 until the indicated start time is reached, at which point the UE may begin to install the software update automatically (e.g., without human interaction).

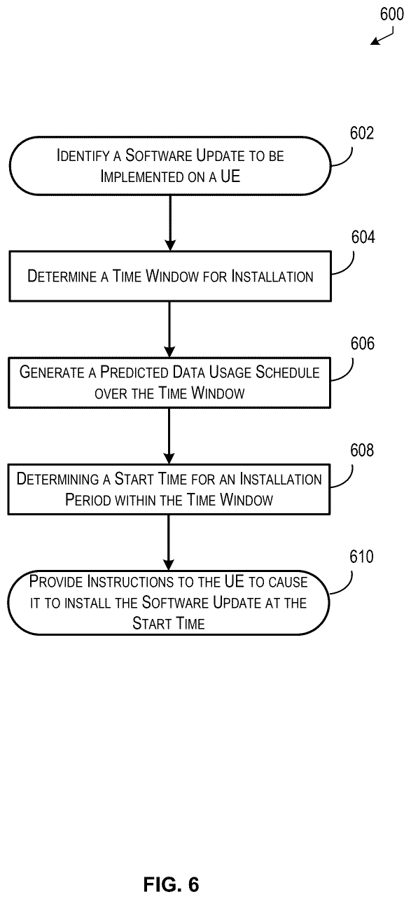

FIG. 6 depicts a flow diagram illustrating an exemplary process for optimization automatization of software update installation in accordance with at least some embodiments. The process 600 may be performed by a scheduling node in communication with a user equipment, such as the scheduling node 122 in communication with the UE 108 as described in relation to FIG. 1 above. As noted elsewhere, the user equipment may be a mobile device that operates using a network connection, such as a cellular phone.

At 602, the process 600 may involve identifying a software update to be implemented on a user equipment in communication with the network node. In embodiments, the software update is identified based on a current version of a software application installed on the user equipment being outdated. In such embodiments, the software application may be configured to access a service managed by an application server in communication with the network node. In some cases, the software application interacts with an application programming interface (API) for the service.

At 604, the process 600 may involve determining a time window within which the software update is to be implemented. For example, the software update may be implemented for the software application, one or more other software applications on the UE, or a combination of both. Such a time window may be determined based on information about the software update. For example, a length of the time window may be determined based on a level of criticality associate with the service managed by the application server. In this example, the length of the time window is inversely correlated to the level of criticality.

At 606, the process 600 may involve generating a predicted data usage schedule associated with the time window. Such a predicted data usage schedule may be generated based on information about the user equipment. For example, the information about the user equipment may include information about historic data usage by the user equipment. In some cases, the information about the user equipment may be received from a home subscriber server (HSS) in communication with the network node. In some cases, the predicted data usage schedule may be generated using one or more trained machine learning models.

At 608, the process 600 may involve determining a start time for an installation period associated with the software update. The installation period may represent an amount of time that an installation of the software update is predicted to take. In embodiments, a length of the installation period is determined based on a size of the software update. In embodiments, the start time may be determined within the time window so that a total predicted data usage over the installation period is minimized.

At 610, the process 600 may involve providing installation instructions to the user equipment to cause the user equipment to install the software update at the start time. The installation instructions may be provided to the user equipment along with the software update to be installed. In some cases, a version of the software update that is provided to the user equipment will be dependent upon a model or type of that user equipment. In embodiments, the installation instructions are stored in a memory of the user equipment until the start time is reached.

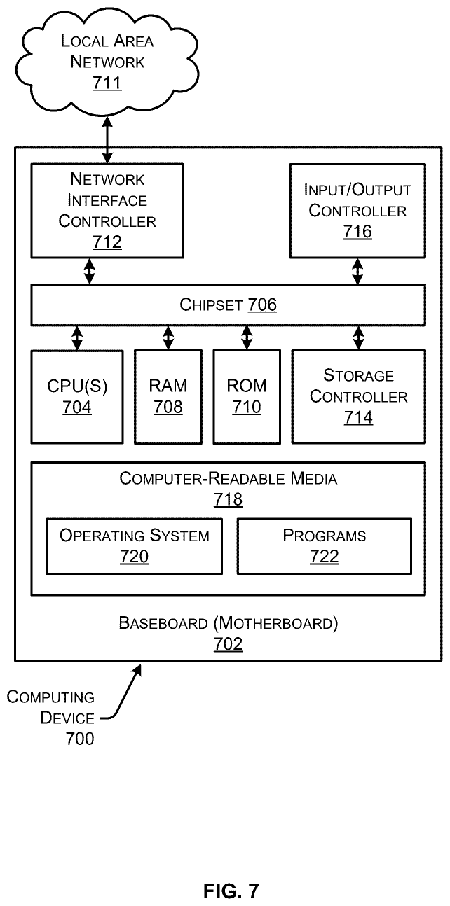

FIG. 7 shows an example computer architecture for a computing device 700 capable of executing program components for implementing the functionality described above. Such a computing device 700 may be implemented as user device (e.g., user equipment 108) or as network node (e.g., scheduling node 122) as described herein. The computer architecture shown in FIG. 7 illustrates a conventional server computer, workstation, desktop computer, laptop, tablet, network appliance, e-reader, smartphone, or other computing device, and can be utilized to execute any of the software components presented herein. The computing device 700 may, in some examples, correspond to a physical server as described herein, and may comprise networked devices such as servers, switches, routers, hubs, bridges, gateways, modems, repeaters, access points, etc.

The computing device 700 includes a baseboard 702, or “motherboard,” which is a printed circuit board to which a multitude of components or devices can be connected by way of a system bus or other electrical communication paths. In one illustrative configuration, one or more central processing units (“CPUs”) referred to as processors 704 operate in conjunction with a chipset 706. The processors 704 can be standard programmable processors that perform arithmetic and logical operations necessary for the operation of the computing device 700.

The processors 704 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 706 provides an interface between the processors 704 and the remainder of the components and devices on the baseboard 702. The chipset 706 can provide an interface to a RAM 708, used as the main memory in the computing device 700. The chipset 706 can further provide an interface to a computer-readable storage medium such as a read-only memory (“ROM”) 710 or non-volatile RAM (“NVRAM”) for storing basic routines that help to startup the computing device 700 and to transfer information between the various components and devices. The ROM 710 or NVRAM can also store other software components necessary for the operation of the computing device 700 in accordance with the configurations described herein.

The computing device 700 can operate in a networked environment using logical connections to remote computing devices and computer systems through a network, such as the network 711. The chipset 706 can include functionality for providing network connectivity through a NIC 712, such as a gigabit Ethernet adapter. The NIC 712 is capable of connecting the computing device 700 to other computing devices over the network 711. It should be appreciated that multiple NICs 712 can be present in the computing device 700, connecting the computer to other types of networks and remote computer systems.

The computing device 700 can be connected to a storage device 718 that provides non-volatile storage for the computer. The storage device 718 can store an operating system 720, programs 722, and data, which have been described in greater detail herein. The storage device 718 can be connected to the computing device 700 through a storage controller 714 connected to the chipset 706. The storage device 718 can consist of one or more physical storage units. The storage controller 714 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computing device 700 can store data on the storage device 718 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 718 is characterized as primary or secondary storage, and the like.

For example, the computing device 700 can store information to the storage device 718 by issuing instructions through the storage controller 714 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 700 can further read information from the storage device 718 by detecting the physical states or characteristics of one or more particular locations within the physical storage units.

In addition to the mass storage device 718 described above, the computing device 700 can have access to other computer-readable storage media to store and retrieve information, such as program modules, data structures, or other data. It should be appreciated by those skilled in the art that computer-readable storage media is any available media that provides for the non-transitory storage of data and that can be accessed by the computing device 700. In some examples, the operations performed by devices as described herein may be supported by one or more devices similar to computing device 700. Stated otherwise, some or all of the operations performed by an edge device, and/or any components included therein, may be performed by one or more computing device 700 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 718 can store an operating system 720 utilized to control the operation of the computing device 700. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 718 can store other system or application programs and data utilized by the computing device 700.

In one embodiment, the storage device 718 or other computer-readable storage media is encoded with computer-executable instructions which, when loaded into the computing device 700, transform the computer from a general-purpose computing system into a special-purpose computer capable of implementing the embodiments described herein. These computer-executable instructions transform the computing device 700 by specifying how the CPUs (e.g., processors 704) transition between states, as described above. According to one embodiment, the computing device 700 has access to computer-readable storage media storing computer-executable instructions which, when executed by the computing device 700, perform the various processes described above with regard to the other figures. The computing device 700 can also include computer-readable storage media having instructions stored thereupon for performing any of the other computer-implemented operations described herein.

The computing device 700 can also include one or more input/output controllers 716 for receiving and processing input from a number of input devices, such as a keyboard, a mouse, a touchpad, a touch screen, an electronic stylus, or other type of input device. Similarly, an input/output controller 716 can provide output to a display, such as a computer monitor, a flat-panel display, a digital projector, a printer, or other type of output device. It will be appreciated that the computing device 700 might not include all of the components shown in FIG. 7, can include other components that are not explicitly shown in FIG. 7, or might utilize an architecture completely different than that shown in FIG. 7.

As described herein, the computing device 700 may include one or more hardware processors 704 (processors) configured to execute one or more stored instructions. The processors 704 may comprise one or more cores. Further, the computing device 700 may include one or more network interfaces configured to provide communications between the computing device 700 and other devices, such as the communications described herein as being performed by an edge device. The network interfaces may include devices configured to couple to personal area networks (PANs), wired and wireless local area networks (LANs), wired and wireless wide area networks (WANs), and so forth. More specifically, the network interfaces include the mechanical, electrical, and signaling circuitry for communicating data over physical links coupled to the network 711. The network interfaces may be configured to transmit and/or receive data using a variety of different communication protocols. Notably, a physical network interface may also be used to implement one or more virtual network interfaces, such as for virtual private network (VPN) access, known to those skilled in the art. In one example, the network interfaces may include devices compatible with Ethernet, Wi-Fi™, and so forth.

The programs 722 may comprise any type of programs or processes to perform the techniques described in this disclosure. The programs 722 may comprise any type of program that cause the computing device 700 to perform techniques for communicating with other devices using any type of protocol or standard usable for determining connectivity.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

In general, routing module contains computer executable instructions executed by the processor to perform functions provided by one or more routing protocols. These functions may, on capable devices, be configured to manage a routing/forwarding table (a data structure) containing, e.g., data used to make routing forwarding decisions. In various cases, connectivity may be discovered and known, prior to computing routes to any destination in the network, e.g., link state routing such as Open Shortest Path First (OSPF), or Intermediate-System-to-Intermediate-System (ISIS), or Optimized Link State Routing (OLSR). For instance, paths may be computed using a shortest path first (SPF) or constrained shortest path first (CSPF) approach. Conversely, neighbors may first be discovered (i.e., a priori knowledge of network topology is not known) and, in response to a needed route to a destination, send a route request into the network to determine which neighboring node may be used to reach the desired destination. Example protocols that take this approach include Ad-hoc On-demand Distance Vector (AODV), Dynamic Source Routing (DSR), DYnamic MANET On-demand Routing (DYMO), etc. Notably, on devices not capable or configured to store routing entries, routing module may implement a process that consists solely of providing mechanisms necessary for source routing techniques. That is, for source routing, other devices in the network can tell the less capable devices exactly where to send the packets, and the less capable devices simply forward the packets as directed.

In various embodiments, as detailed further below, one or more module executed on the computing device 800 may also include computer executable instructions that, when executed by processor(s), cause computing device 800 to perform the techniques described herein. To do so, in some embodiments, a module may utilize machine learning. In general, machine learning is concerned with the design and the development of techniques that take as input empirical data (such as network statistics and performance indicators) and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

In various embodiments, one or more module included on the computing device 800 may employ one or more supervised, unsupervised, or semi-supervised machine learning models. Generally, supervised learning entails the use of a training set of data, as noted above, that is used to train the model to apply labels to the input data. For example, the training data may include sample telemetry that has been labeled as normal or anomalous. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that path evaluation process can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for time series), random forest classification, or the like.

The performance of a machine learning model can be evaluated in a number of ways based on the number of true positives, false positives, true negatives, and/or false negatives of the model. For example, the false positives of the model may refer to the number of times the model incorrectly predicted an undesirable behavior of a path, such as its delay, packet loss, and/or jitter exceeding one or more thresholds. Conversely, the false negatives of the model may refer to the number of times the model incorrectly predicted acceptable path behavior. True negatives and positives may refer to the number of times the model correctly predicted whether the behavior of the path will be acceptable or unacceptable, respectively. Related to these measurements are the concepts of recall and precision. Generally, recall refers to the ratio of true positives to the sum of true positives and false negatives, which quantifies the sensitivity of the model. Similarly, precision refers to the ratio of true positives to the sum of true and false positives.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

Although the descriptions provided herein may be in the context of certain radio access technologies, networks, and network topologies, such as 5G/NR mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

What is claimed is:

1. A method comprising:
identifying, by a network node, a software update to be implemented on a user equipment in communication with the network node;
determining, by the network node based on information about the software update, a time window within which the software update is to be implemented;
generating, by the network node based on information about the user equipment, a predicted data usage schedule associated with the time window;
determining, by the network node based on the predicted data usage schedule, a start time for an installation period associated with the software update; and
providing, by the network node, installation instructions to the user equipment to cause the user equipment to install the software update at the start time.

2. The method of claim 1, wherein the software update is associated with a service managed by an application server in communication with the network node.

3. The method of claim 2, wherein a length of the time window is determined based on a level of criticality associate with the service managed by the application server.

4. The method of claim 3, wherein the length of the time window is inversely correlated to the level of criticality.

5. The method of claim 1, wherein a length of the installation period is determined based on a size of the software update.

6. The method of claim 1, wherein the start time is determined within the time window so that a total predicted data usage over the installation period is minimized.

7. The method of claim 1, wherein the information about the user equipment comprises information about historic data usage by the user equipment.

8. The method of claim 7, wherein the information about the user equipment is received from a home subscriber server (HSS) in communication with the network node.

9. The method of claim 1, wherein the predicted data usage schedule is generated using one or more trained machine learning models.

10. A network node comprising:
one or more processors; and
one or more non-transitory computer-readable media storing computer-executable instructions that, when executed by the one or more processors, cause the network node to perform operations comprising:
identify a software update to be implemented on a user equipment in communication with the network node;
determine, based on information about the software update, a time window within which the software update is to be implemented;
generate, based on information about the user equipment, a predicted data usage schedule associated with the time window;
determine, based on the predicted data usage schedule, a start time for an installation period associated with the software update; and
provide installation instructions to the user equipment to cause the user equipment to install the software update at the start time.

11. The network node of claim 10, wherein the software update is identified based on a current version of a software application installed on the user equipment being outdated.

12. The network node of claim 11, wherein the software application is configured to access a service managed by an application server in communication with the network node.

13. The network node of claim 12, wherein the software application interacts with an application programming interface (API) for the service.

14. The network node of claim 10, wherein the installation period represents an amount of time that an installation of the software update is predicted to take.

15. The network node of claim 10, wherein the installation instructions are stored in a memory of the user equipment until the start time is reached.

16. The network node of claim 10, wherein the installation instructions are provided to the user equipment along with the software update to be installed.

17. One or more non-transitory computer-readable media storing computer-executable instructions that, when executed by one or more processors, cause the one or more processors to perform operations comprising:
identifying a software update to be implemented on a user equipment;
determining, based on information about the software update, a time window within which the software update is to be implemented;
generating, based on information about the user equipment, a predicted data usage schedule associated with the time window;
determining, based on the predicted data usage schedule, a start time for an installation period associated with the software update; and
providing installation instructions to the user equipment to cause the user equipment to install the software update at the start time.

18. The one or more non-transitory computer-readable media of claim 17, wherein the predicted data usage schedule represents a predicted amount of data usage for the user equipment with respect to time.

19. The one or more non-transitory computer-readable media of claim 17, wherein the software update is associated with a service managed by an access server and the software update is identified in response to the user equipment attempting to access the service.

20. The one or more non-transitory computer-readable media of claim 17, wherein the operations further comprise storing multiple versions of the software update, wherein a version of the software update to be installed on the user equipment is determined based on the information about the user equipment.
